(19) United States
(12) Patent Application Publication
(10) Pub. No.: US 2025/0218295 A1
(43) Pub. Date: Jul. 3, 2025

(54) TRAVELING CONTROL DEVICE FOR VEHICLE

(71) Applicant: TOYOTA JIDOSHA KABUSHIKI KAISHA, Toyota-shi (JP)

(72) Inventor: Yusuke FUKUI, Miyoshi-shi (JP)

(73) Assignee: TOYOTA JIDOSHA KABUSHIKI KAISHA, Toyota-shi (JP)

(21) Appl. No.: 18/978,796

(22) Filed: Dec. 12, 2024

(30) Foreign Application Priority Data
Dec. 28, 2023 (JP) 2023-222282

(51) Int. Cl. G08G 1/0967; G08G 1/16

(52) U.S. Cl. CPC G08G 1/096791; G08G 1/166

(57) ABSTRACT

A traveling control device for a vehicle includes a driving assistance ECU configured to, when a determination is made that there is a possibility that a host vehicle will enter a narrow road with a road width less than a reference value and that the host vehicle will attempt to pass a second vehicle on the narrow road, announce, to at least one of an occupant of the host vehicle and an occupant of the second vehicle, an alert for avoiding a situation in which the host vehicle and the second vehicle pass each other on the narrow road.

### CROSS-REFERENCE TO RELATED APPLICATION

This application claims priority to Japanese Patent Application No. 2023-222282 filed on Dec. 28, 2023. The disclosure of the above-identified application, including the specification, drawings, and claims, is incorporated by reference herein in its entirety.

### BACKGROUND

### 1. Technical Field

The present disclosure relates to a traveling control device for a vehicle, such as an automobile. More specifically, the present disclosure relates to a traveling control device that announces an alert during narrow-road travel.

### 2. Description of Related Art

As one of traveling control devices for vehicles, such as automobiles, there is known a traveling control device that controls traveling of a host vehicle such that the host vehicle can pass an oncoming vehicle without requesting driving to be performed by a driver, when the host vehicle and the oncoming vehicle pass each other on a road having a relatively narrow width.

For example, Japanese Unexamined Patent Application Publication No. 2008-174023 (JP 2008-174023 A) describes a traveling control device configured to enable a host vehicle to pass an oncoming vehicle without being driven by a driver by autonomously driving the host vehicle while the host vehicle transits and receives traveling situation information to and from the oncoming vehicle via inter-vehicle communication.

### SUMMARY

In a traveling control device in the related art, such as the traveling control device described in JP 2008-174023 A, the host vehicle is autonomously driven on the assumption that the host vehicle will pass the oncoming vehicle. Accordingly, depending on behavior of the oncoming vehicle, there is a likelihood that the host vehicle will come into contact with the oncoming vehicle, and the danger of contact when the host vehicle passes the oncoming vehicle cannot be completely eliminated.

Further, in the traveling control device in the related art, such as the traveling control device described in JP 2008-174023 A, there is a problem in that a situation in which the host vehicle and the oncoming vehicle are attempting to enter a narrow road on which it is difficult or not possible for the host vehicle and the oncoming vehicle to pass each other cannot be handled.

The present disclosure provides a traveling control device that is improved so as to, when there is a possibility that a host vehicle and a second vehicle will attempt to pass each other on a narrow road on which it is difficult or not possible for the host vehicle and the second vehicle to pass each other, reduce a likelihood that the host vehicle and the second vehicle will pass each other, by reducing a likelihood that both the host vehicle and the second vehicle will enter the narrow road.

An aspect of the present disclosure provides a traveling control device for a vehicle. The traveling control device includes a control unit (driving assistance ECU) configured to, when a determination is made that there is a possibility that a host vehicle will enter a narrow road with a road width less than a reference value set in advance and that the host vehicle will attempt to pass a second vehicle on the narrow road, announce, to at least one of an occupant of the host vehicle and an occupant of the second vehicle, an alert for avoiding a situation in which the host vehicle and the second vehicle pass each other on the narrow road.

According to the above-described configuration, when a determination is made that there is a possibility that the host vehicle will enter the narrow road and that the host vehicle will attempt to pass the second vehicle on the narrow road, the alert for avoiding a situation in which the host vehicle and the second vehicle pass each other on the narrow road is announced to at least one of the occupant of the host vehicle and the occupant of the second vehicle.

Accordingly, at least one of the occupant of the host vehicle and the occupant of the second vehicle can reduce a likelihood that both the host vehicle and the second vehicle will enter the narrow road can be reduced by controlling the traveling of the vehicle in accordance with the alert, so that a likelihood that the host vehicle and the second vehicle will pass each other on the narrow road can be reduced.

In the aspect of the present disclosure, the control unit (driving assistance ECU) may be configured to change a content of the alert in accordance with traveling situations of the host vehicle and the second vehicle on the narrow road and surroundings of the narrow road.

According to the above-described aspect, the content of the alert is changed in accordance with the traveling situations of the host vehicle and the second vehicle on the narrow road and the surroundings of the narrow road, so that the alert can be announced with the content corresponding to the traveling situations of the host vehicle and the second vehicle.

In the aspect of the present disclosure, the control unit (driving assistance ECU) may be configured to, when a determination is made that the second vehicle has already entered the narrow road, perform annunciation, to the occupant of the host vehicle, prompting the host vehicle to wait in front of the narrow road without entering the narrow road.

According to the above-described aspect, when a determination is made that the second vehicle has already entered the narrow road, the annunciation, to the occupant of the host vehicle, prompting the host vehicle to wait in front of the narrow road without entering the narrow road is performed, so that a likelihood that the host vehicle will enter the narrow road besides the second vehicle can be reduced.

In the aspect of the present disclosure, the control unit (driving assistance ECU) may be configured to, when a determination is made that the second vehicle has not entered the narrow road, estimate a time needed for the host vehicle and the second vehicle to enter the narrow road.

The control unit may be configured to decide an order of priority of the host vehicle and the second vehicle regarding entry into the narrow road, such that the order of priority of the vehicle of which the estimated time is shorter is higher.

The control unit may be configured to announce the alert in accordance with a content corresponding to the decided order of priority.

According to the above-described aspect, when a determination is made that the second vehicle has not entered the narrow road, the order of priority regarding the entry into the narrow road is decided such that the order of priority of the vehicle of which the time needed for the host vehicle and the second vehicle to enter the narrow road is shorter is higher. The alert is announced with the content corresponding to the decided order of priority. Therefore, a likelihood that both the host vehicle and the second vehicle will enter the narrow road can be reduced, and the order of the entry into the narrow road can be decided based on the time needed for the host vehicle and the second vehicle enter the narrow road.

Further, in the aspect of the present disclosure, the control unit (driving assistance ECU) may be configured to, when there is a third vehicle attempting to enter the narrow road, estimate a time needed for the host vehicle and the third vehicle to enter the narrow road.

The control unit may be configured to decide an order of priority of the host vehicle and the third vehicle regarding entry into the narrow road, such that the order of priority of the vehicle of which the estimated time is shorter is higher.

The control unit may be configured to announce the alert to at least one of the host vehicle and the third vehicle in accordance with a content corresponding to the decided order of priority.

According to the above-described aspect, when there is the third vehicle attempting to enter the narrow road, the time needed for the host vehicle and the third vehicle to enter the narrow road is estimated. Further, the order of priority of the host vehicle and the third vehicle regarding the entry into the narrow road is decided such that the order of priority of the vehicle of which the estimated time is shorter is higher, and the alert is announced to at least one of the host vehicle and the third vehicle in accordance with a content corresponding to the decided order of priority. Therefore, a likelihood that both the host vehicle and the third vehicle will enter the narrow road can be reduced, and the order of the entry into the narrow road can be decided based on the time needed for the host vehicle and the third vehicle enter the narrow road.

In the present application, the term “reference value” for a road width may be a value that is greater than a vehicle width of a regular-size vehicle and is smaller than a width that would make it difficult for two regular-size vehicles to safely and easily pass each other. For example, the reference value may be a value that is equal to or greater than 2 meters and equal to or less than 4 meters. The term “narrow road” means a road of which the width is less than the reference value, and the term “wide road” means a road of which the width is equal to or greater than the reference value.

In the above description, in order to assist in understanding of the present disclosure, the names and/or the reference signs used in the following embodiment are added in parentheses to the configurations of the present disclosure corresponding to the embodiment. However, each component of the present disclosure is not limited to the component of the embodiment corresponding to the name and/or the reference sign added in parentheses. Other objects, other features, and accompanying advantages of the present disclosure will be readily understood from the description of the embodiment of the present disclosure described with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a traveling control device according to an embodiment;

FIG. 2 is a flowchart corresponding to a program of alert control during narrow-road travel in the embodiment;

FIG. 3 is a diagram showing a situation in which the host vehicle travels on a wide road and approaches the narrow road, and a second vehicle has already entered the narrow road and travels in a direction approaching the host vehicle;

FIG. 4 is a diagram showing a situation in which the host vehicle travels on the wide road and approaches the narrow road, the second vehicle has already entered the narrow road and travels in a direction approaching the host vehicle, and a third vehicle travels on the wide road and attempts to enter the narrow road following the second vehicle;

FIG. 5 is a diagram showing a situation in which the host vehicle travels on the wide road and approaches the narrow road, and the second vehicle travels on the wide road in a direction approaching the host vehicle and approaches the narrow road; and

FIG. 6 is a diagram showing a situation in which the host vehicle travels on the wide road and approaches the narrow road, and the second vehicle travels on the wide road in a direction approaching the host vehicle, but attempts to move to a side road.

### DETAILED DESCRIPTION OF EMBODIMENTS

Hereinafter, a traveling control device according to an embodiment of the present disclosure will be described in detail with reference to the accompanying drawings.

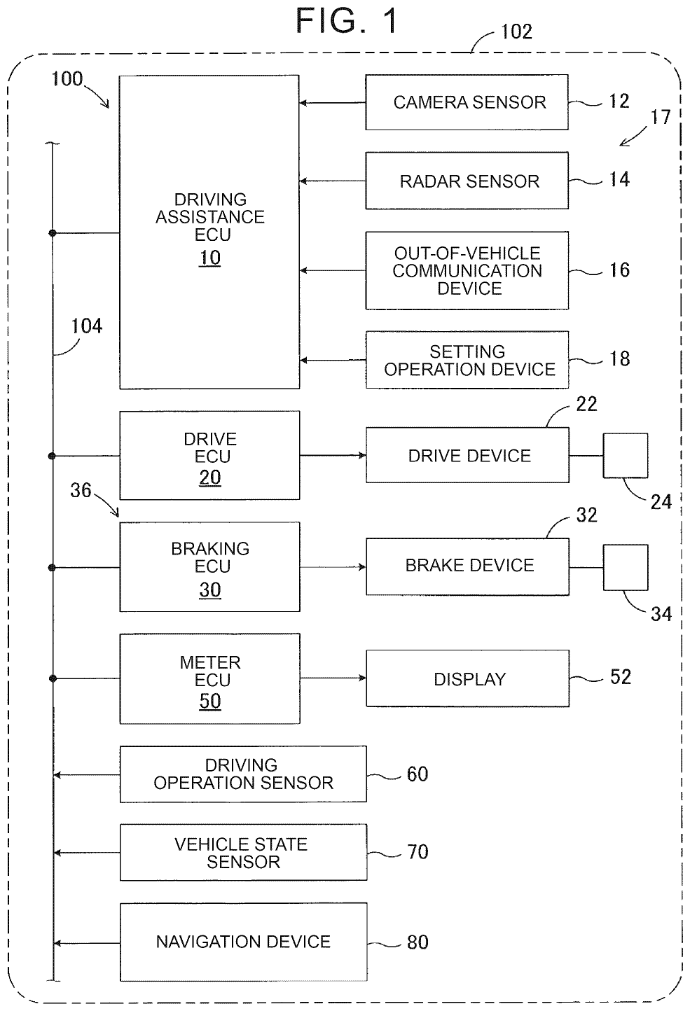

As shown in FIG. 1, a traveling control device 100 according to the embodiment of the present disclosure is applied to a vehicle 102 and includes a driving assistance ECU 10. The vehicle 102 is an autonomous vehicle, and includes a driving ECU 20, a braking ECU 30, and a meter ECU 50. The term “ECU” means an electronic control unit including a microcomputer as a main part. In order to distinguish the vehicle 102 from other vehicles, the vehicle 102 is referred to as a host vehicle as needed.

A microcomputer of each ECU includes a CPU, a ROM, a RAM, a readable and writable non-volatile memory (N/M), an interface (I/F), and the like. The CPU realizes various functions by executing instructions (programs, routines) stored in the ROM. Furthermore, these ECUs are connected to each other in a data-exchangeable (communicable) manner via a controller area network (CAN) 104. Therefore, detected values of sensors (including switches) connected to a specific ECU are transmitted to the other ECUs as well.

The driving assistance ECU 10 is a central control device that performs driving assistance travel control, such as the alert control, distance-to-following-vehicle control, and lane keeping control during narrow-road travel. In the embodiment, the driving assistance ECU 10 cooperates with the other ECUs to perform the alert control during narrow-road travel for the vehicle 102 and a second vehicle, as will be described in detail later.

A camera sensor 12, a radar sensor 14, an out-of-vehicle communication device 16, and a setting operation device 18 are connected to the driving assistance ECU 10. The camera sensor 12 and the radar sensor 14 include a plurality of camera devices and a plurality of radar devices, respectively, and function as a target information acquisition device 17 that acquires target information of surroundings of the vehicle 102.

Each camera device of the camera sensor 12 includes a camera unit that captures an image of the surroundings of the vehicle 102, and a recognition unit that analyzes image data obtained by capturing the image by the camera unit and recognizes a target, such as a white line of a road or the second vehicle, although not shown in the drawing. The recognition unit supplies information about the recognized target to the driving assistance ECU 10 at predetermined time intervals.

Each radar device of the radar sensor 14 includes a radar transceiver and a signal processor (not shown). The radar transceiver emits a radio wave (hereinafter, referred to as “millimeter wave”) in a millimeter wave band, and receives a millimeter wave (that is, a reflected wave) reflected by a three-dimensional object (for example, the second vehicle or a bicycle) existing in an emission range. The signal processor supplies information indicating a distance between the host vehicle and the three-dimensional object, a relative speed between the host vehicle and the three-dimensional object, a relative position (direction) of the three-dimensional object with respect to the host vehicle, and the like to the driving assistance ECU 10 at predetermined time intervals based on a phase difference between the transmitted millimeter wave and the received reflected wave, an attenuation level of the reflected wave, a time from the transmission of the millimeter wave to the reception of the reflected wave, and the like. Instead of the radar sensor 14 or in addition to the radar sensor 14, light detection and ranging (LiDAR) may be used.

The out-of-vehicle communication device 16 is a device that exchanges information (position, speed, vehicle control information, and the like) on a surrounding vehicle by wireless communication between the surrounding vehicle, the road infrastructure, the out-of-vehicle information center, and the like and the host vehicle 102. As will be described in detail later, the out-of-vehicle communication device 16 transmits and receives annunciation information of an alert for avoiding a situation in which the host vehicle and other vehicles pass each other on the narrow road, by wireless communication.

A braking device 32 is connected to the braking ECU 30 to decelerate the vehicle 102 by braking by applying a braking force to wheels 34. In a normal state, the braking ECU 30 controls the braking device so that the braking force generated by the braking device 32 changes in accordance with a braking operation by a driver, and performs, when a command signal is received from the driving assistance ECU 10, automatic braking by controlling the braking device 32 based on the command signal.

Thus, the braking ECU 30 and the braking device 32 cooperate with each other to function as an automated braking device 36. When the braking force is applied to the wheels by collision prevention control or the like, a brake lamp (not shown in FIG. 1) is turned on.

The meter ECU 50 is connected with a touch panel-type display 52 for displaying a situation of control by the driving assistance ECU 10 and an alarm device 54 for issuing an alarm. The display 52 may be, for example, a multi-information display in which meters and various types of information are displayed, or may be a display of a navigation device 80 described later. As will be described later, when a signal is received from the driving assistance ECU 10, the display 52 displays information on the alert for avoiding a situation in which the host vehicle and the second vehicle pass each other on the narrow road.

A driving operation sensor 60 and a vehicle state sensor 70 are connected to the CAN 104. Information (referred to as sensor information) detected by the driving operation sensor 60 and the vehicle state sensor 70 is transmitted to the CAN 104. The sensor information transmitted to the CAN 104 can be appropriately used in each ECU. The sensor information is information of sensors connected to a specific ECU, and may be transmitted from the specific ECU to the CAN 104.

The driving operation sensor 60 includes a drive operation amount sensor that detects an operation amount of an accelerator pedal, a braking operation amount sensor that detects a master cylinder pressure or a depression force applied to a brake pedal, and a brake switch that detects whether or not the brake pedal is operated. The driving operation sensor 60 includes a steering angle sensor that detects a steering angle, a steering torque sensor that detects a steering torque, and the like.

The vehicle state sensor 70 includes a vehicle speed sensor that detects a vehicle speed V of the vehicle 102, a longitudinal acceleration sensor that detects longitudinal acceleration of the vehicle, a lateral acceleration sensor that detects lateral acceleration of the vehicle, a yaw rate sensor that detects a yaw rate of the vehicle.

In addition, the navigation device 80 is also connected to the CAN 104. The navigation device 80 includes a GPS receiver that detects a position of the vehicle 102, a storage device that stores map information and road information, and a communication device that acquires latest information of the map information and the road information from the outside. In particular, the road information may include information on the narrow road on which it is not possible or difficult for vehicles traveling in opposite directions to pass each other. The navigation device 80 need not be provided.

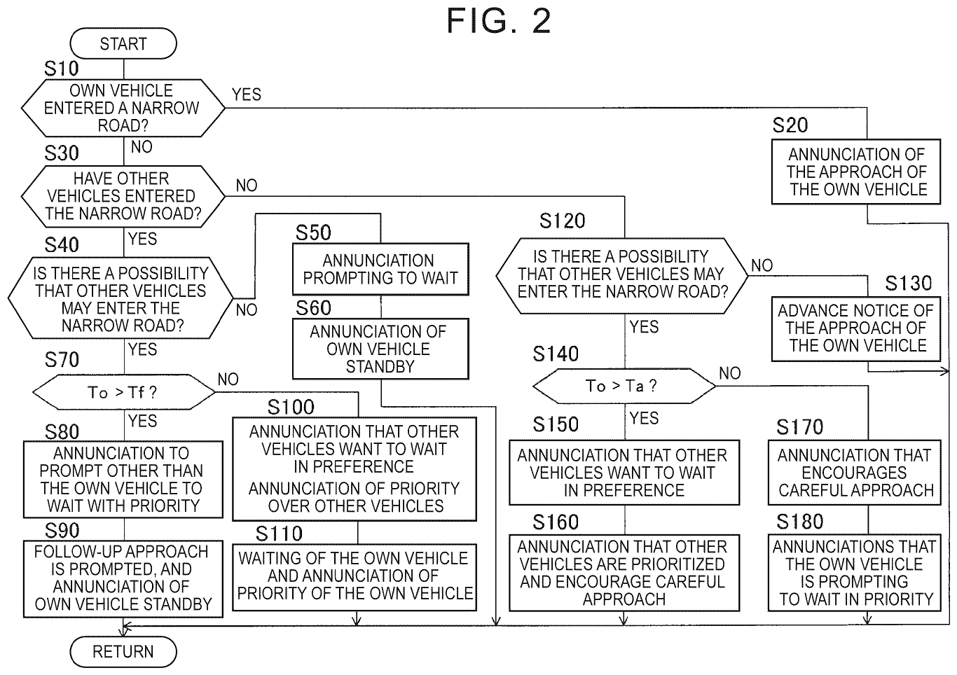

In the embodiment, the ROM of the driving assistance ECU 10 stores a program of the alert control during narrow-road travel, corresponding to a flowchart shown in FIG. 2.

### Alert Control During Narrow-Road Travel (FIG. 2)

Next, the alert control during narrow-road travel in the embodiment will be described with reference to the flowchart shown in FIG. 2. The alert control during narrow-road travel according to the flowchart shown in FIG. 2 is repeatedly executed at predetermined time intervals by the CPU of the driving assistance ECU 10 in a situation in which the switch of the setting operation device 18 is on. In the following description, the alert control during narrow-road travel is referred to as “the present control”.

Further, S20, S50, S80, S100, S150, S170 described later are steps for performing annunciation to a driver of the host vehicle. On the other hand, S60, S90, S110, S130, S160, S180 described later are steps for performing annunciation to a driver of a vehicle other than the host vehicle.

First, in S10, the CPU determines whether or not there is a narrow road of which a road width is less than a reference value of the road width around the surroundings including the front of the host vehicle 102, based on the target information acquired by the target information acquisition device 17 and/or the information from the navigation device 80 and/or the information from the out-of-vehicle communication device 16. When a negative determination is made, the present control ends once. On the other hand, when an affirmative determination is made, the CPU determines whether or not the host vehicle 102 has already entered the narrow road based on the target information acquired by the target information acquisition device 17 and/or the information from the navigation device 80 and/or the information from the out-of-vehicle communication device 16. When a negative determination is made, the present control proceeds to S30, and when an affirmative determination is made, the present control proceeds to S20.

In S20, the CPU outputs the command signal to the out-of-vehicle communication device 16 to announce, to the driver of the surrounding vehicle, that the host vehicle has already entered the narrow road by the out-of-vehicle communication.

In S30, the CPU determines whether or not the second vehicle has already entered the narrow road based on the target information acquired by the target information acquisition device 17 and/or the information from the navigation device 80 and/or the information from the out-of-vehicle communication device 16. When a negative determination is made, the present control proceeds to S120, and when an affirmative determination is made, the present control proceeds to S40.

In S40, the CPU determines whether or not there is a possibility that a third vehicle, that is, a vehicle other than the host vehicle and the second vehicle that has already entered the narrow road, will enter the narrow road based on the target information acquired by the target information acquisition device 17 and/or the information from the out-of-vehicle communication device 16. When an affirmative determination is made, the present control proceeds to S70, and when a negative determination is made, the present control proceeds to S50.

In S50, the CPU outputs the command signal to the meter ECU 50, and performs, on the display 52, display indicating that the second vehicle has already entered the narrow road, thereby performing annunciation, to the driver of the vehicle 102, indicating that the second vehicle has already entered the narrow road and prompting the host vehicle to wait in front of the narrow road.

In S60, the CPU outputs the command signal to the out-of-vehicle communication device 16 to announce, to the driver of the surrounding vehicle, that the host vehicle is waiting in front of the narrow road by the out-of-vehicle communication.

In S70, the CPU estimates a time To needed for the host vehicle 102 to reach the narrow road and a time Tf needed for the third vehicle to reach the narrow road based on the target information acquired by the target information acquisition device 17 and/or the information from the out-of-vehicle communication device 16. Further, the CPU determines whether or not the time To is greater than the time Tf. When a negative determination is made, a determination is made that an order of priority of the host vehicle is higher than an order of priority of the third vehicle, and the present control proceeds to S100. On the other hand, when an affirmative determination is made, a determination is made that the order of priority of the third vehicle is higher than the order of priority of the host vehicle, and the present control proceeds to S80.

A travel distance Lo between the host vehicle 102 and an entrance of the narrow road and an average vehicle speed Voa of the host vehicle may be estimated, and the travel distance Lo may be divided by the average vehicle speed Voa to estimate the time To. Similarly, a travel distance Lf between the third vehicle and the entrance of the narrow road and an average vehicle speed Vfa of the third vehicle may be estimated, and the travel distance Lf may be divided by the average vehicle speed Vfa to estimate the time Tf.

In S80, the CPU outputs the command signal to the meter ECU 50, and performs, on the display 52, display indicating that the order of priority of the vehicle other than the host vehicle, that is, the order of priority of the second vehicle and the third vehicle is higher than the order of priority of the host vehicle and prompting the host vehicle to wait in front of the narrow road, thereby performing annunciation of the above-described situation to the driver of the host vehicle.

In S90, the CPU outputs the command signal to the out-of-vehicle communication device 16, thereby prompting the third vehicle to enter the narrow road following the second vehicle, and announcing, to the driver of the second vehicle and the driver of the third vehicle, that the host vehicle is waiting in front of the narrow road.

In S100, the CPU outputs the command signal to the meter ECU 50, and performs, on the display 52, display indicating that the order of priority of the second vehicle is higher than the order of priority of the host vehicle and prompting the host vehicle to wait in front of the narrow road, thereby announcing the above-described situation to the driver of the host vehicle. Further, the CPU displays on the display 52 that the order of priority of the host vehicle is higher than the order of priority of the third vehicle, thereby announcing the above-situation to the driver of the host vehicle.

In S110, the CPU outputs the command signal to the out-of-vehicle communication device 16, thereby announcing, to the driver of the second vehicle and the driver of the third vehicle, that the host vehicle is waiting in front of the narrow road and that the order of priority of the host vehicle is higher than the order of priority of the third vehicle.

In S120, the CPU determines whether or not there is a possibility that the second vehicle will enter the narrow road based on the target information acquired by the target information acquisition device 17 and/or the information from the out-of-vehicle communication device 16. When an affirmative determination is made, the present control proceeds to S140, and when a negative determination is made, the present control proceeds to S130.

In S130, the CPU outputs the command signal to the out-of-vehicle communication device 16, thereby announcing, to the driver of the surrounding vehicle, that the host vehicle will enter the narrow road.

In S140, the CPU estimates the time To needed for the host vehicle 102 to reach the narrow road and a time Ta needed for the second vehicle to reach the narrow road based on the target information acquired by the target information acquisition device 17 and/or the information from the out-of-vehicle communication device 16. Further, the CPU determines whether or not the time To is greater than the time Ta. When a negative determination is made, a determination is made that the order of priority of the host vehicle is higher than the order of priority of the second vehicle, and the present control proceeds to S170. On the other hand, when an affirmative determination is made, a determination is made that the order of priority of the second vehicle is higher than the order of priority of the host vehicle, and the present control proceeds to S150.

The travel distance Lo between the host vehicle 102 and the entrance of the narrow road and the average vehicle speed Voa of the host vehicle may be estimated, and the travel distance Lo may be divided by the average vehicle speed Voa to estimate the time To. Similarly, a travel distance La between the second vehicle and the entrance of the narrow road and an average vehicle speed Vaa of the second vehicle may be estimated, and the travel distance La may be divided by the average vehicle speed Vaa to estimate the time Ta.

In S150, the CPU outputs the command signal to the meter ECU 50, and performs, on the display 52, display indicating that the order of priority of the second vehicle is higher than the order of priority of the host vehicle and prompting the host vehicle to wait in front of the narrow road, thereby announcing the above-described situation to the driver of the host vehicle.

In S160, the CPU outputs the command signal to the out-of-vehicle communication device 16, thereby performing annunciation, to the driver of the second vehicle, indicating that the order of priority of the second vehicle is higher than the order of priority of the host vehicle and prompting the second vehicle to carefully enter the narrow road.

In S170, the CPU outputs the command signal to the meter ECU 50 and performs, on the display 52, display prompting the host vehicle to carefully enter the narrow road, thereby announcing the above-described situation to the driver of the host vehicle.

In S180, the CPU outputs the command signal to the out-of-vehicle communication device 16, thereby performing annunciation, to the driver of the second vehicle, of an advance notice that the order of priority of the host vehicle is higher than the order of priority of the second vehicle and the host vehicle will enter the narrow road.

### Operations of Embodiment

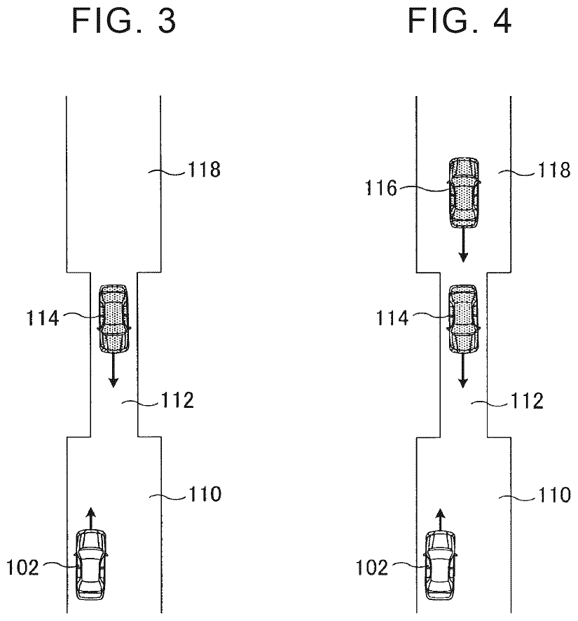

Next, with reference to FIGS. 3 to 6, the operations of the embodiment will be described for various cases in which a positional relationship between the host vehicle 102 and the second vehicle with respect to the narrow road is different.

### A: When Host Vehicle Has Not Entered Narrow Road and Second Vehicle Has Already Entered Narrow Road

### A-1: When There is No Possibility That Third Vehicle Will Enter Narrow Road (FIG. 3)

FIG. 3 shows a situation in which the host vehicle 102 travels on a wide road 110 and approaches a narrow road 112, and a second vehicle 114 has already entered the narrow road 112 and travels in a direction approaching the host vehicle 102.

In such a case, a negative determination, an affirmative determination, and a negative determination are made in S10, S30, S40, respectively. Therefore, in S50, the driver of the host vehicle 102 is given annunciation indicating that the second vehicle has already entered the narrow road and prompting the host vehicle to wait in front of the narrow road. In addition, in S60, the driver of the surrounding vehicle is given annunciation that the host vehicle is waiting in front of the narrow road by the out-of-vehicle communication.

Therefore, the driver of the host vehicle can determine to wait in front of the narrow road so that the host vehicle does not pass the second vehicle on the narrow road 112. In addition, the driver of the second vehicle can travel on the narrow road in expectation that the host vehicle will wait in front of the narrow road.

### A-2: When There is Possibility That Third Vehicle Will Enter Narrow Road (FIG. 4)

FIG. 4 shows a situation in which the host vehicle 102 travels on the wide road 110 and approaches the narrow road 112, the second vehicle 114 has already entered the narrow road 112 and travels in a direction approaching the host vehicle 102, and a third vehicle 116 travels on the wide road 118 and attempts to enter the narrow road 112 following the second vehicle.

In such a case, a negative determination is made in S10, and an affirmative determination is made in S30, S40. Therefore, a determination of S70 is made for the times To, Tf.

### (1) When Time To is Greater Than Time Tf

In S70, an affirmative determination is made. Therefore, in S80, the driver of the host vehicle is given annunciation indicating that the order of priority of the second vehicle and the third vehicle is higher than the order of priority of the host vehicle and prompting the host vehicle to wait in front of the narrow road. Further, in S90, the third vehicle is prompted to enter the narrow road following the second vehicle, and the driver of the second vehicle and the driver of the third vehicle are given annunciation that the host vehicle is waiting in front of the narrow road.

Therefore, the driver of the host vehicle can determine to wait in front of the narrow road so that the host vehicle does not pass the second vehicle and the third vehicle on the narrow road 112. In addition, the driver of the second vehicle and the driver of the third vehicle can travel on the narrow road in expectation that the host vehicle will wait in front of the narrow road.

### (2) When Time To is Equal To or Less Than Time Tf

In S70, a negative determination is made. Therefore, in S100, the driver of the host vehicle is given annunciation indicating that the order of priority of the second vehicle is higher than the order of priority of the host vehicle and the order of priority of the host vehicle is higher than the order of priority of the third vehicle, and prompting the host vehicle to wait in front of the narrow road. Further, in S110, the driver of the second vehicle and the driver of the third vehicle are given annunciation that the host vehicle is waiting in front of the narrow road and that the order of priority of the host vehicle is higher than the order of priority of the third vehicle.

Therefore, the driver of the host vehicle can determine to wait in front of the narrow road so that the host vehicle does not pass the second vehicle on the narrow road 112, and enter the narrow road ahead of the third vehicle when the narrow-road travel of the second vehicle is completed. Further, the driver of the second vehicle can travel on the narrow road in expectation that the host vehicle will wait in front of the narrow road, and the driver of the third vehicle can determine to wait in front of the narrow road until the narrow-road travel of the host vehicle is completed.

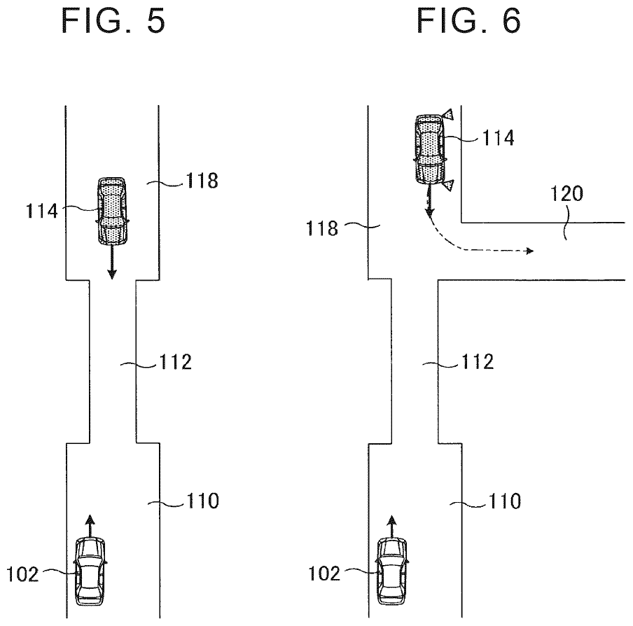

### B: When Host Vehicle Has Not Entered Narrow Road and There is Possibility That Second Vehicle Will Enter Narrow Road (FIG. 5)

FIG. 5 shows a situation in which the host vehicle 102 travels on the wide road 110 and approaches the narrow road 112, and the second vehicle 114 travels on the wide road 118 in a direction approaching the host vehicle 102 and approaches the narrow road 112.

In such a case, a negative determination is made in S10, S30, and an affirmative determination is made in S120. Therefore, a determination of S140 is made for the times To, Ta.

### (1) When Time To is Greater Than Time Ta

In S140, an affirmative determination is made. Therefore, in S150, the driver of the host vehicle is given annunciation indicating that the order of priority of the second vehicle is higher than the order of priority of the host vehicle and prompting the host vehicle to wait in front of the narrow road. In addition, in S160, the driver of the second vehicle is given annunciation indicating that the order of priority of the second vehicle is higher than the order of priority of the host vehicle and prompting the second vehicle to carefully enter the narrow road.

Therefore, the driver of the host vehicle can determine to wait in front of the narrow road until the narrow-road travel of the second vehicle is completed. In addition, the driver of the second vehicle can determine to cause his/her vehicle to enter the narrow road 112.

### (2) When Time To is Equal To or Less Than Time Ta

In S140, a negative determination is made. Therefore, in S170, the driver of the host vehicle is given annunciation prompting the host vehicle to carefully enter the narrow road. In addition, in S180, the driver of the second vehicle is given annunciation that the order of priority of the host vehicle is higher than the order of priority of the second vehicle and the host vehicle will enter the narrow road.

Therefore, the driver of the host vehicle can determine to cause the host vehicle to enter the narrow road 112. Further, the driver of the second vehicle can determine to wait in front of the narrow road until the narrow-road travel of the host vehicle is completed.

### C: When Host Vehicle Has Not Entered Narrow Road and There is No Possibility That Second Vehicle Will Enter Narrow Road (FIG. 6)

FIG. 6 shows a situation in which the host vehicle 102 travels on the wide road 110 and approaches the narrow road 112, and the second vehicle 114 travels on the wide road 118 in a direction approaching the host vehicle 102, but attempts to move to a side road 120.

In such a case, a negative determination is made in S10, S30, S120. Therefore, in S130, the driver of the surrounding vehicle is given annunciation that the host vehicle will enter the narrow road. Therefore, the driver of the surrounding vehicle can recognize that the host vehicle will enter the narrow road.

As can be seen from the above description, according to the present disclosure, when a determination is made that there is a possibility that the host vehicle 102 will enter the narrow road 112 (S10) and that the host vehicle will attempt to pass the second vehicle on the narrow road (S120), the alert for avoiding a situation in which the host vehicle and the second vehicle pass each other on the narrow road is announced to at least one of the occupant of the host vehicle and the occupant of the second vehicle (S140 to S180).

Accordingly, at least one of the occupant of the host vehicle and the occupant of the second vehicle can reduce a likelihood that both the host vehicle and the second vehicle will enter the narrow road can be reduced by controlling the traveling of the vehicle in accordance with the alert. As a result, it is possible to reduce a likelihood that the host vehicle and the second vehicle will pass each other on the narrow road.

Further, according to the present disclosure, a content of the alert is changed in accordance with the traveling situations of the host vehicle 102 and the second vehicle 114 on the narrow road 112 and the surroundings of the narrow road 112 (S40 to S180). Therefore, it is possible to announce the alert based on the content corresponding to the traveling situations of the host vehicle and the second vehicle.

Further, according to the present disclosure, when a determination is made that the second vehicle 114 has already entered the narrow road 112 (S30), annunciation, to the occupant of the host vehicle 102, prompting the host vehicle to wait in front of the narrow road without entering the narrow road is performed (S90). Therefore, it is possible to reduce a likelihood that the host vehicle will enter the narrow road in addition to the second vehicle.

Further, according to the present disclosure, when a determination is made that the second vehicle 114 has not entered the narrow road 112 (S30), the order of priority regarding the entry into the narrow road is decided such that the order of priority of the vehicle of which the time needed for the host vehicle 102 and the second vehicle to enter the narrow road is shorter is higher (S140), and the alert is announced in accordance with the content corresponding to the decided order of priority (S150 to S180). Therefore, a likelihood that both the host vehicle and the second vehicle will enter the narrow road can be reduced, and the order of the entry into the narrow road can be decided based on the time needed for the host vehicle and the second vehicle enter the narrow road.

Further, according to the present disclosure, when there is the third vehicle 116 attempting to enter the narrow road 112, the time needed for the host vehicle and the third vehicle to enter the narrow road is estimated. Further, the order of priority of the host vehicle and the third vehicle regarding the entry into the narrow road is decided such that the order of priority of the vehicle of which the estimated time is shorter is higher (S70), and the alert is announced to at least one of the host vehicle and the third vehicle in accordance with a content corresponding to the decided order of priority (S80 to S110). Therefore, a likelihood that both the host vehicle and the third vehicle will enter the narrow road can be reduced, and the order of the entry into the narrow road can be decided based on the time needed for the host vehicle and the third vehicle enter the narrow road.

The present disclosure has been described in detail above with respect to a specific embodiment. However, it is obvious to those skilled in the art that the present disclosure is not limited to the above-described embodiment, and various other embodiments are possible within the scope of the present disclosure.

For example, in the above-described embodiment, when a negative determination is made in S10, S30 and subsequent steps are executed. However, in S10, when a negative determination is made, a determination is made as to whether or not the alert is announced from the second vehicle equipped with a traveling control device similar to the traveling control device according to the embodiment of the present disclosure. When a negative determination is made, S30 and subsequent steps may be executed, and when an affirmative determination is made, the alert from the second vehicle may be obeyed.

In addition, in the above-described embodiment, the type of the second vehicle and the third vehicle is not determined, but a determination may be made as to whether the second vehicle or the third vehicle is an emergency vehicle, such as an ambulance, a fire engine, or a patrol car. When an affirmative determination is made, the order of priority of the vehicle may be set to the highest priority, and the alert may be announced in accordance with the order of priority.

What is claimed is:

1. A traveling control device for a vehicle, the traveling control device comprising a control unit,
wherein the control unit is configured to, when a determination is made that there is a possibility that a host vehicle will enter a narrow road with a road width less than a reference value set in advance and that the host vehicle will attempt to pass a second vehicle on the narrow road, announce, to at least one of an occupant of the host vehicle and an occupant of the second vehicle, an alert for avoiding a situation in which the host vehicle and the second vehicle pass each other on the narrow road.

2. The traveling control device according to claim 1, wherein the control unit is configured to change a content of the alert in accordance with traveling situations of the host vehicle and the second vehicle on the narrow road and surroundings of the narrow road.

3. The traveling control device according to claim 1, wherein the control unit is configured to, when a determination is made that the second vehicle has already entered the narrow road, perform annunciation, to the occupant of the host vehicle, prompting the host vehicle to wait in front of the narrow road without entering the narrow road.

4. The traveling control device according to claim 1, wherein:
the control unit is configured to, when a determination is made that the second vehicle has not entered the narrow road, estimate a time needed for the host vehicle and the second vehicle to enter the narrow road;
the control unit is configured to decide an order of priority of the host vehicle and the second vehicle regarding entry into the narrow road, such that the order of priority of the vehicle of which the estimated time is shorter is higher; and
the control unit is configured to announce the alert in accordance with a content corresponding to the decided order of priority.

5. The traveling control device according to claim 3, wherein:
the control unit is configured to, when there is a third vehicle attempting to enter the narrow road, estimate a time needed for the host vehicle and the third vehicle to enter the narrow road;
the control unit is configured to decide an order of priority of the host vehicle and the third vehicle regarding entry into the narrow road, such that the order of priority of the vehicle of which the estimated time is shorter is higher; and
the control unit is configured to announce the alert to at least one of the host vehicle and the third vehicle in accordance with a content corresponding to the decided order of priority.
